(19) United States
(12) Patent Application Publication
(10) Pub. No.: US 2009/0020193 A1
(43) Pub. Date: Jan. 22, 2009

(54) RARE EARTH SINTERED MAGNET AND PROCESS FOR PRODUCING THE SAME

(75) Inventors: Akiyasu Ohta, Osaka (JP); Hideyuki Morimoto, Osaka (JP)

Correspondence Address: HITACHI METALS, LTD.;C/O KEATING & BENNETT, LLP, 1800 Alexander Bell Drive, SUITE 200, Reston, VA, 20191, US

(73) Assignee: HITACHI METALS, LTD., Minato-ku, Tokyo (JP)

(21) Appl. No.: 11/911,369

(22) PCT Filed: Apr. 14, 2006
(86) PCT No.: PCT/JP2006/307956

§ 371 Date: Oct. 12, 2007

(30) Foreign Application Priority Data
Apr. 15, 2005 (JP) 2005-119088

(51) Int. Cl. C21D 9/00; H01F 1/00

(52) U.S. Cl. 148/559; 148/302

(57) ABSTRACT

In a process of producing an R—Fe—B based rare-earth sintered magnet, first, an R—Fe—B based sintered magnet, including, as a main phase, R₂Fe₁₄B type compound crystal grains with a light rare-earth element RL (which is Nd and/or Pr) as a main rare-earth element R, is provided. Next, the surface of the sintered magnet body is coated with an RHM alloy layer including RH (which is at least one rare-earth element selected from Dy, Ho and Tb) and a metal M (which is at least one metallic element selected from Al, Cu, Co, Fe and Ag). Thereafter, a heat treatment is conducted at about 500° C. to about 1,000° C. within a vacuum or an Ar atmosphere, thereby diffusing the metallic element M and the heavy rare-earth element RH inward from the surface of the rare-earth sintered magnet body.

### BACKGROUND OF THE INVENTION

1. Field of the Invention

The present invention relates to an R—Fe—B based rare-earth sintered magnet including crystal grains of an R₂Fe₁₄B type compound (where R is a rare-earth element) as a main phase and a method for producing such a magnet. More particularly, the present invention relates to an R—Fe—B based rare-earth sintered magnet, which includes a light rare-earth element RL (which is at least one of Nd and Pr) as an essential rare-earth element R and in which a portion of the light rare-earth element RL is replaced with a heavy rare-earth element RH (which is at least one element selected from the group consisting of Dy, Ho and Tb).

2. Description of the Related Art

An R—Fe—B based rare-earth sintered magnet, including an Nd₂Fe₁₄B type compound phase as a main phase, is known as a permanent magnet with the highest performance, and has been used in various types of motors such as a voice coil motor (VCM) for a hard disk drive and a motor for a hybrid car and in numerous types of consumer electronic appliances. When used in motors and various other devices, the R—Fe—B based rare-earth sintered magnet should exhibit thermal resistance and coercivity that are high enough to withstand an operating environment at an elevated temperature.

As a means for increasing the coercivity of an R—Fe—B based rare-earth sintered magnet, a molten alloy, including a heavy rare-earth element RH as an additional element, is used. According to this method, the light rare-earth element R, which is included as a rare-earth element R in an R₂Fe₁₄B phase, is replaced with a heavy rare-earth element RH, and therefore, the magnetocrystalline anisotropy (which is a physical quantity that determines the coercivity) of the R₂Fe₁₄B phase improves. However, although the magnetic moment of the light rare-earth element RL in the R₂Fe₁₄B phase has the same direction as that of Fe, the magnetic moments of the heavy rare-earth element RH and Fe have mutually opposite directions. That is why the greater the percentage of the light rare-earth element RL replaced with the heavy rare-earth element RH, the lower the remanence Br.

Meanwhile, as the heavy rare-earth element RH is one of rare natural resources, its use is preferably cut down as much as possible. For these reasons, the method in which the light rare-earth element RL is entirely replaced with the heavy rare-earth element RH is not preferred.

To get the coercivity increased effectively with the addition of a relatively small amount of the heavy rare-earth element RH, it was proposed that an alloy or compound powder, including a lot of the heavy rare-earth element RH, be added to a main phase material alloy powder including a lot of the light rare-earth element RL and then the mixture be compacted and sintered. According to this method, the heavy rare-earth element RH is distributed a lot in the vicinity of the grain boundary of the R₂Fe₁₄B phase, and therefore, the magnetocrystalline anisotropy of the R₂Fe₁₄B phase can be improved efficiency on the outer periphery of the main phase. The R—Fe—B based rare-earth sintered magnet has a nucleation-type coercivity generating mechanism. That is why if a lot of the heavy rare-earth element RH is distributed on the outer periphery of the main phase (i.e., near the grain boundary thereof), the magnetocrystalline anisotropy of all crystal grains is improved, the nucleation of reverse magnetic domains can be minimized, and the coercivity increases as a result. At the core of the crystal grains that does not contribute to increasing the coercivity, no light rare-earth element RL is replaced with the heavy rare-earth element RH. Consequently, the decrease in remanence Br can be minimized there, too.

If this method is actually adopted, however, the heavy rare-earth element RH has an increased diffusion rate during the sintering process (which is carried out at a temperature of 1,000° C. to 1,200° C. on an industrial scale) and may diffuse to reach the core of the crystal grains, too. For that reason, it is not easy to obtain the expected crystal structure.

As another method for increasing the coercivity of an R—Fe—B based rare-earth sintered magnet, a metal, an alloy or a compound including a heavy rare-earth element RH is deposited on the surface of the sintered magnet and then thermally treated and diffused. Then, the coercivity could be recovered or increased without decreasing the remanence so much (see Patent Documents Nos. 1 and 2).

Patent Document No. 1 teaches forming a thin-film alloy layer, including 1.0 at % to 50.0 at % of at least one element that is selected from the group consisting of Ti, W, Pt, Au, Cr, Ni, Cu, Co, Al, Ta and Ag and R as the balance (which is at least one element selected from the group consisting of Ce, La, Nd, Pr, Dy, Ho and Tb), on the surface of a sintered magnet body to be ground.

Patent Document No. 2 discloses that a metal element R (which is at least one rare-earth element selected from the group consisting of Y, Nd, Dy, Pr, Ho and Tb) is diffused to a depth that is at least equal to the radius of crystal grains exposed on the uppermost surface of a small-sized magnet, thereby repairing the damage done on the machined surface and increasing (BH)max.

Patent Document No. 1: Japanese Patent Application Laid-Open Publication No. 62-192566

Patent Document No. 2: Japanese Patent Application Laid-Open Publication No. 2004-304038

Both of the techniques disclosed in Patent Documents Nos. 1 and 2 were developed to repair the damage done on the machined surface of a sintered magnet. That is why the metal element, diffused inward from the surface, can reach no farther than a surface region of the magnet. For that reason, if the magnet has a thickness of 3 mm or more, the coercivity cannot be increased so effectively.

Magnets for EPS and HEV motors, which are expected to expand their markets in the near future, need to be rare-earth sintered magnets with a thickness of at least 3 mm and preferably 5 mm or more. To increase the coercivity of a sintered magnet with such a thickness, a technique of diffusing the heavy rare-earth element RH efficiently throughout the inside of the magnet needs to be developed.

### SUMMARY OF THE INVENTION

In order to overcome the problems described above, preferred embodiments of the present invention provide an R—Fe—B based rare-earth sintered magnet, in which a small amount of heavy rare-earth element RH is used efficiently and has been diffused uniformly everywhere, even if the magnet is relatively thick.

Other features, elements, processes, steps, characteristics and advantages of the present invention will become more apparent from the following detailed description of preferred embodiments of the present invention with reference to the attached drawings.

### BRIEF DESCRIPTION OF DRAWINGS

FIG. 1A is a cross-sectional view schematically illustrating a cross section of an R—Fe—B based rare-earth sintered magnet, of which the surface is coated with an RHM alloy layer.

FIG. 1B is a cross-sectional view schematically illustrating a cross section of an R—Fe—B based rare-earth sintered magnet, of which the surface is coated with only an RH layer, for the purpose of comparison.

FIG. 1C is a cross-sectional view schematically illustrating the internal texture of the magnet shown in FIG. 1A that has been subjected to a diffusion process.

FIG. 1D is a cross-sectional view schematically illustrating the internal texture of the magnet shown in FIG. 1B that has been subjected to the diffusion process.

FIGS. 2A and 2B are graphs respectively showing how the coercivity HcJ and the remanence Br changed with the thickness t of sintered magnets in a situation where a sample with a Dy layer on the surface of the magnet and a sample without the Dy layer were thermally treated at about 900° C. for about 30 minutes.

FIG. 3 schematically illustrates an evaporation system that can be used effectively in a process according to the present invention.

FIG. 4 is a graph showing the demagnetization curves of Example #1 and Comparative Example #1.

FIG. 5 is a graph showing the demagnetization curves of Example #2 and Comparative Example #2.

FIG. 6 is a graph showing the demagnetization curves of Example #3 and Comparative Example #3.

### DETAILED DESCRIPTION OF PREFERRED EMBODIMENTS

A rare-earth sintered magnet according to a preferred embodiment of the present invention preferably includes: an R—Fe—B based rare-earth sintered magnet body, and an RHM alloy layer, which includes a heavy rare-earth element RH (which is at least one rare-earth element selected from the group consisting of Dy, Ho and Tb) and a metal M (which is at least one metallic element selected from the group consisting of Al, Cu, Fe and Ag) and which has been formed on the surface of the R—Fe—B based sintered magnet body.

In one preferred embodiment, the R—Fe—B based rare-earth sintered magnet body has a thickness of about 10 mm or less.

In another preferred embodiment, the RHM alloy layer includes at least one alloy selected from the group consisting of DyAl, DyCu, DyFe, DyAg, TbAl, TbCu, TbFe, TbAg, DyAlCu, DyFeAl, DyFeAg and TbAlCu.

A method for producing a rare-earth sintered magnet according to a preferred embodiment of the present invention includes the steps of: providing an R—Fe—B based sintered magnet body; forming an RHM alloy layer, which includes RH (which is at least one rare-earth element selected from the group consisting of Dy, Ho and Tb) and a metal M (which is at least one metallic element selected from the group consisting of Al, Cu, Fe and Ag), on the surface of the R—Fe—B based sintered magnet body; and conducting a heat treatment at a temperature of about 500° C. to about 1,000° C.

In one preferred embodiment, the step of forming the RHM alloy layer includes forming the RHM alloy layer by an evaporation process, a vacuum evaporation process, a sputtering process, an ion plating process, an ion vapor deposition (IND) process, an electrochemical vapor deposition (EVD) process or a dipping process.

In another preferred embodiment, the step of forming the RHM alloy layer includes making the RHM alloy layer of at least one alloy selected from the group consisting of DyAl, DyCu, DyFe, DyAg, TbAl, TbCu, TbFe, TbAg, DyAlCu, DyFeAl and DyFeAg.

In still another preferred embodiment, the step of forming the RHM alloy layer and the step of conducting the heat treatment are repeatedly performed a number of times.

In yet another preferred embodiment, the method further includes the step of heating the R—Fe—B based sintered magnet body to a temperature of about 500° C. to about 1,000° C. before the RHM alloy layer is formed thereon.

In yet another preferred embodiment, the R—Fe—B based sintered magnet has a thickness of about 10 mm or less.

According to various preferred embodiments of the present invention, by taking advantage of the phenomenon that the diffusion of a heavy rare-earth element RH (which is at least one element selected from the group consisting of Dy, Ho and Tb) is promoted by a metal M (which is at least one metallic element selected from the group consisting of Al, Cu, Fe and Ag), the heavy rare-earth element RH is supplied to a deep region inside a sintered magnet body. In this manner, the light rare-earth element RL can be replaced with the heavy rare-earth element RH efficiently on the outer periphery of the main phase. As a result, the coercivity HcJ can be increased with the decrease in remanence Br minimized.

The surface of a rare-earth sintered magnet according to various preferred embodiments of the present invention is preferably coated with an RHM alloy layer including an RH (which is at least one rare-earth element selected from the group consisting of Dy, Ho and Tb) and a metal M (which is at least one metallic element selected from the group consisting of Al, Cu, Fe and Ag).

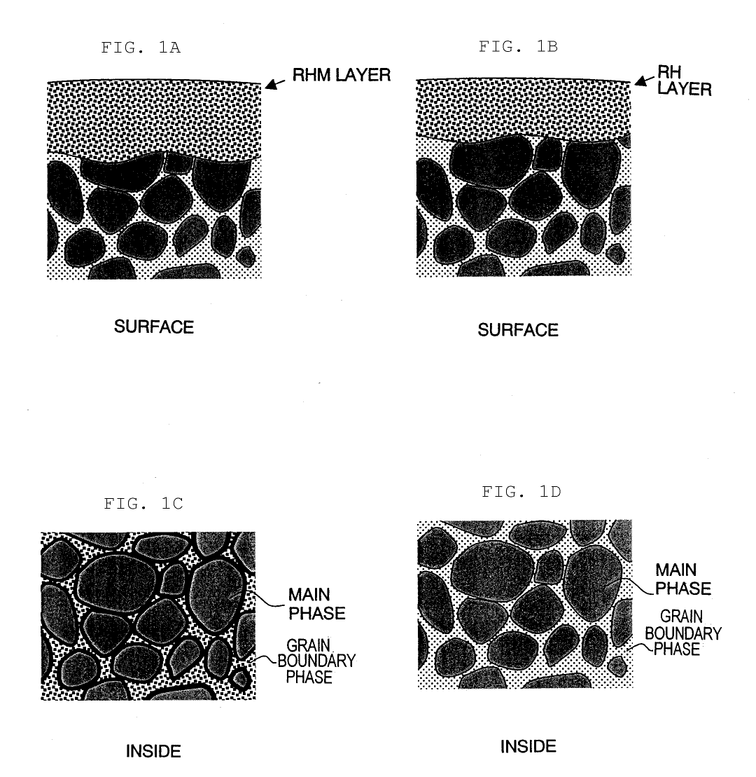

FIG. 1A schematically illustrates a cross section of an R—Fe—B based rare-earth sintered magnet body, of which the surface is coated with an RHM alloy layer including a metallic element M and a heavy rare-earth element RH. For the purpose of comparison, FIG. 1B schematically illustrates a cross section of a conventional R—Fe—B based rare-earth sintered magnet, of which the surface is coated with only an RH layer.

The diffusion process according to a preferred embodiment of the present invention is carried out by heating a sintered magnet body including the RHM alloy layer on the surface. As a result of this heating, the metallic element M with a relatively low melting point, included in the RHM alloy layer, diffuses inward inside the sintered body and then the heavy rare-earth element RH diffuses through the grain boundary inside the sintered body. The metallic element M lowers the melting point of the grain boundary phase (i.e., an R-rich grain boundary phase), and therefore, the diffusion of the heavy rare-earth element RH through the grain boundary would be promoted. Consequently, the heavy rare-earth element RH can be diffused efficiently inside the sintered body even at a lower temperature.

FIG. 1C schematically illustrates the internal texture of the magnet shown in FIG. 1A that has been subjected to the diffusion process, while FIG. 1D schematically illustrates the internal texture of the magnet shown in FIG. 1B that has been subjected to the diffusion process. As schematically illustrated in FIG. 1C, the heavy rare-earth element RH has diffused through the grain boundary to enter the outer periphery of the main phase. On the other hand, as schematically illustrated in FIG. 1D, the heavy rare-earth element RH that has been supplied on the surface has not diffused inside the magnet.

If the grain boundary diffusion of the heavy rare-earth element RH is promoted in this manner due to the action of the metallic element M, the rate at which the heavy rare-earth element RH is diffusing inward and entering the inside of the magnet will be higher than the rate at which the same element is diffusing and entering the main phase that is located in the vicinity of the surface of the sintered magnet body. Such diffusion of the heavy rare-earth element RH inside the main phase will be referred to herein as “volume diffusion”. The presence of the metallic element M causes the grain boundary diffusion more preferentially than the volume diffusion, thus eventually reducing the volume diffusion. According to a preferred embodiment of the present invention, the concentrations of the metallic element M and the heavy rare-earth element RH are higher on the grain boundary than inside the main phase crystal grains as a result of the grain boundary diffusion. Specifically, according to a preferred embodiment of the present invention, the heavy rare-earth element RH can easily diffuse to reach a depth of about 0.5 mm or more as measured from the surface of the magnet.

According to a preferred embodiment of the present invention, the heat treatment for diffusing the metallic element M is preferably carried out at a temperature that is at least equal to the melting point of the metal M but less than approximately 1,000° C.

By conducting such a heat treatment, the light rare-earth element RL included in the R₂Fe₁₄B main phase crystal grains can be partially replaced with the heavy rare-earth element RH that has been diffused from the surface of the sintered body, and a layer including the heavy rare-earth element RH at a relatively high concentration (with a thickness of several nm, for example) can be formed on the outer periphery of the R₂Fe₁₄B main phase.

The R—Fe—B based rare-earth sintered magnet has a nucleation type coercivity generating mechanism. Therefore, if the magnetocrystalline anisotropy is increased on the outer periphery of a main phase, the nucleation of reverse magnetic domains can be reduced in the vicinity of the grain boundary phase surrounding the main phase. As a result, the coercivity HcJ of the main phase can be increased effectively as a whole. According to a preferred embodiment of the present invention, the heavy rare-earth replacement layer can be formed on the outer periphery of the main phase not only in a surface region of the sintered magnet body but also deep inside the magnet. Consequently, the magnetocrystalline anisotropy can be increased in the entire magnet and the coercivity HcJ of the overall magnet increases sufficiently. Therefore, according to a preferred embodiment of the present invention, even if the amount of the heavy rare-earth element RH consumed is small, the heavy rare-earth element RH can still diffuse and penetrate deep inside the sintered body. And by forming RH₂Fe₁₄B efficiently on the outer periphery of the main phase, the coercivity HcJ can be increased with the decrease in remanence Br minimized.

It should be noted that the magnetocrystalline anisotropy of Tb₂Fe₁₄B is higher than that of Dy₂Fe₁₄B and is about three times as high as that of Nd₂Fe₁₄B. For that reason, the heavy rare-earth element RH to replace the light rare-earth element RL on the outer periphery of the main phase is preferably Tb rather than Dy.

As can be seen easily from the foregoing description, according to a preferred embodiment of the present invention, there is no need to add the heavy rare-earth element RH to the material alloy. That is to say, a known R—Fe—B based rare-earth sintered magnet, including a light rare-earth element RL (which is at least one of Nd and Pr) as the rare-earth element R, is provided, and a low-melting metal and a heavy rare-earth element are diffused inward from the surface of the magnet. If only the conventional heavy rare-earth layer were formed on the surface of the magnet, it would be difficult to diffuse the heavy rare-earth element deep inside the magnet even at an elevated diffusion temperature. However, according to a preferred embodiment of the present invention, the metallic element M in the RHM layer lowers the melting point of the grain boundary phase and can promote the diffusion of RH. That is why the heavy rare-earth element can also be supplied efficiently to the outer periphery of the main phase located deep inside the magnet.

According to the results of experiments the present inventors carried out, the weight ratio of M to RH in the RHM layer on the surface of the sintered magnet body preferably falls within the range of about 1/100 to about 5/1, more preferably from about 1/20 to about 2/1. By setting the weight ratio within such a range, the metal M can promote the diffusion of the heavy rare-earth element RH effectively. As a result, the heavy rare-earth element RH can be diffused inside the magnet efficiently and the coercivity can be increased effectively.

The weight of RH deposited on the surface of the sintered magnet body, i.e., the total weight of the heavy rare-earth element RH included in the magnet, is preferably adjusted so as to account for about 0.1 wt % to about 1 wt % of the entire magnet. This range is preferred for the following reasons. Specifically, if the weight of RH were less than about 0.1 wt % of the magnet, the amount of the heavy rare-earth element RH would be too small to diffuse. That is why if the magnet thickened, the heavy rare-earth element RH could not be diffused to the outer periphery of every main phase included in the magnet. On the other hand, if the weight of RH exceeded about 1 wt % of the magnet, then the heavy rare-earth element RH would be in excess of the amount needed to form an RH concentrated layer on the outer periphery of the main phase. Also, if an excessive amount of heavy rare-earth element RH was supplied, then RH would diffuse and enter the main phase to possibly decrease the remanence Br.

According to a preferred embodiment of the present invention, even if the magnet has a thickness of about 3 mm or more, the remanence Br and coercivity HcJ of the magnet can be both increased by adding a very small amount of heavy rare-earth element RH and a high-performance magnet with magnetic properties that never deteriorate even at high temperatures can be provided. Such a high-performance magnet contributes significantly to realizing an ultra small high-output motor. The effects of various preferred embodiments of the present invention that utilize the grain boundary diffusion are achieved particularly significantly in a magnet with a thickness of about 10 mm or less.

If the atmosphere in which the RHM alloy is heated to diffuse and permeate from the surface of the magnet has as high a purity as that of a normal high-purity argon gas currently available, then atmospheric gases (such as oxygen, water vapor, carbon dioxide and nitrogen gases) included in the argon gas turn at least a portion of the RHM alloy into an oxide, a carbide and a nitride. As a result, the RHM alloy could not permeate through the surface of the magnet efficiently. For that reason, the respective process steps of the diffusion process are preferably carried out at a pressure of about 10⁻⁷ Torr or less and within a pure atmosphere in which the atmospheric gases such as oxygen and water vapor have concentrations of several tens of ppm or less. The concentrations of the atmospheric impurity gases included in the atmosphere when the RHM alloy is heated and diffused are preferably about 50 ppm or less, more preferably about 10 ppm or less.

Also, if the RHM alloy is deposited with one or multiple rare-earth sintered magnet bodies rotatably arranged on either a wire rod or a base, a broad range of the surface (preferably the entire surface) of the magnet body can be coated with the RHM alloy layer. In the process step of depositing the RHM layer, a method in which multiple rare-earth sintered magnet bodies are put in a wire basket and held in a tumbling state may be adopted. By using a rotatable barrel jig, the RHM alloy can be easily deposited on even magnets of usual shapes such as arch- and fan-shaped magnets.

When the RHM alloy layer is formed by evaporation, the diffusion process may be performed in the heat treatment furnace after the sintered magnet body has been unloaded from an evaporation system. Alternatively, the heating process may also be carried out while the RHM alloy is being deposited in the evaporation system. The heating process in the evaporation system may be conducted using a heater. Or the temperature of the sintered magnet body during the deposition process may be raised to about 800° C. by performing a surface sputtering process, for example. Still alternatively, the sintered magnet body may be heated to a temperature of about 500° C. to about 1,000° C. before the evaporation process and the RHM alloy being deposited by the evaporation process may be diffused using that heat.

A preferred evaporation system for carrying out the manufacturing process of the present invention is shown in FIG. 1. The evaporation process may also be performed using an electron beam heating technique (which is called an “EB evaporation process”) instead of using the evaporation system shown in FIG. 1.

It should be noted that a rare-earth metallic element is usually easily oxidizable and has as high a melting point as about 1,400° C. For these reasons, an RHM alloy such as DyAl, DyCu, DyFe, DyAg, TbAl, TbCu, TbFe, TbAg, DyAlCu, DyFeAl, DyFeAg or TbAlCu is preferably used for the evaporation process. Optionally, to reduce the diffusion into the main phase, the process step of forming an RHM alloy layer with a thickness of about 5 μm or less and a diffusion process step that follows the former process step may be repeatedly carried out a number of times.

The mole fraction of the metal M in the RHM alloy influences the melting point of the alloy. That is why, by controlling the mole fraction of the metal M, the melting point can be lowered. As the melting point of the RHM alloy is preferably adjusted to about 1,000° C. or less, the mole fraction of the metal M is preferably set such that the melting point does not exceed approximately 1,000° C. If the RHM alloy had an excessively high melting point, R-rich phases could melt in the rare-earth magnet during the diffusion/heat treatment process and the grain boundary diffusion could not advance sufficiently.

Hereinafter, an example of a preferred embodiment of a method for producing an R—Fe—B based rare-earth sintered magnet according to the present invention will be described.

### Material Alloy

First, an alloy including about 25 mass % to about 40 mass % of a light rare-earth element RL, about 0.6 mass % to about 1.6 mass % of B (boron) and Fe and inevitably contained impurities as the balance is provided. A portion of B may be replaced with C (carbon) and a portion (about 50 at % or less) of Fe may be replaced with another transition metal element such as Co or Ni. For various purposes, this alloy may contain about 0.01 mass % to about 1.0 mass % of at least one additive element that is selected from the group consisting of Al, Si, Ti, V, Cr, Mn, Ni, Cu, Zn, Ga, Zr, Nb, Mo, Ag, In, Sn, Hf, Ta, W, Pb and Bi.

Such an alloy is preferably made by quenching a melt of a material alloy by a strip casting process, for example. Hereinafter, a method of making a rapidly solidified alloy by a strip casting process will be described.

First, a material alloy with the composition described above is melted by an induction heating process within an argon atmosphere to obtain a melt of the material alloy. Next, this melt is kept heated at about 1,350° C. and then quenched by a single roller process, thereby obtaining a flake-like alloy block with a thickness of about 0.3 mm. Then, the alloy block thus obtained is pulverized into flakes with a size of about 1 mm to about 10 mm before being subjected to the next hydrogen pulverization process. Such a method of making a material alloy by a strip casting process is disclosed in U.S. Pat. No. 5,383,978, for example.

### Coarse Pulverization Process

Next, the material alloy block that has been coarsely pulverized into flakes is loaded into a hydrogen furnace and then subjected to a hydrogen decrepitation process (which will be sometimes referred to herein as a “hydrogen pulverization process”) within the hydrogen furnace. When the hydrogen pulverization process is over, the coarsely pulverized alloy powder is preferably unloaded from the hydrogen furnace in an inert atmosphere so as not to be exposed to the air. This prevents oxidation or heat generation of the coarsely pulverized powder and improves the magnetic properties of the resultant magnet.

As a result of this hydrogen pulverization process, the rare-earth alloy is pulverized to sizes of about 0.1 mm to several millimeters with a mean particle size of about 500 μm or less. After the hydrogen pulverization, the decrepitated material alloy is preferably further crushed to finer sizes and cooled. If the material alloy unloaded still has a relatively high temperature, then the alloy should be cooled for a longer time.

### Fine Pulverization Process

Next, the coarsely pulverized powder is finely pulverized with a jet mill pulverizing machine. A cyclone classifier is connected to the jet mill pulverizing machine for use in this preferred embodiment. The jet mill pulverizing machine is fed with the rare-earth alloy that has been coarsely pulverized in the coarse pulverization process (i.e., the coarsely pulverized powder) and gets the powder further pulverized by its pulverizer. The powder, which has been pulverized by the pulverizer, is then collected in a collecting tank by way of the cyclone classifier. In this manner, a finely pulverized powder with sizes of about 0.1 Mm to about 20 Mm (typically about 3 Mm to about 5 Mm) can be obtained. The pulverizing machine for use in such a fine pulverization process does not have to be a jet mill but may also be an attritor or a ball mill. Optionally, a lubricant such as zinc stearate may be added as an aid for the pulverization process.

### Press Compaction Process

In this preferred embodiment, about 0.3 mass % of lubricant is added to, and mixed with, the magnetic powder, obtained by the method described above, in a rocking mixer, thereby coating the surface of the alloy powder particles with the lubricant. Next, the magnetic powder prepared by the method described above is compacted under an aligning magnetic field using a known press machine. The aligning magnetic field to be applied may have a strength of about 1.5 to about 1.7 tesla (T), for example. Also, the compacting pressure is set such that the green compact has a green density of about 4 g/cm³ to about 4.5 g/cm³.

### Sintering Process

The powder compact described above is preferably sequentially subjected to the process of maintaining the compact at a temperature of about 650° C. to about 1,000° C. for about 10 to about 240 minutes and then to the process of further sintering the compact at a higher temperature (of about 1,000° C. to about 1,200° C., for example) than in the maintaining process. Particularly when a liquid phase is produced during the sintering process (i.e., when the temperature is in the range of about 650° C. to about 1,000° C.), the R-rich phase on the grain boundary starts to melt to produce the liquid phase. Thereafter, the sintering process advances to form a sintered magnet eventually. The sintered magnet may be subjected to an aging treatment (at a temperature of about 500° C. to about 1,000° C.) if necessary.

### Metal Diffusion Process

Next, to allow the metal M to perform the function of promoting the diffusion of the heavy rare-earth element RH and making the element diffuse and permeate deeper into the magnet more efficiently to achieve the effect of increasing the coercivity, an alloy layer with a composition that realizes the weight ratio described above is preferably formed.

The metal layer may be formed by any deposition process. For example, one of thin-film deposition techniques such as a vacuum evaporation process, a sputtering process, an ion plating process, an Ion vapor deposition (IND) process, an electrochemical vapor deposition (EVD) process and a dipping process may be adopted.

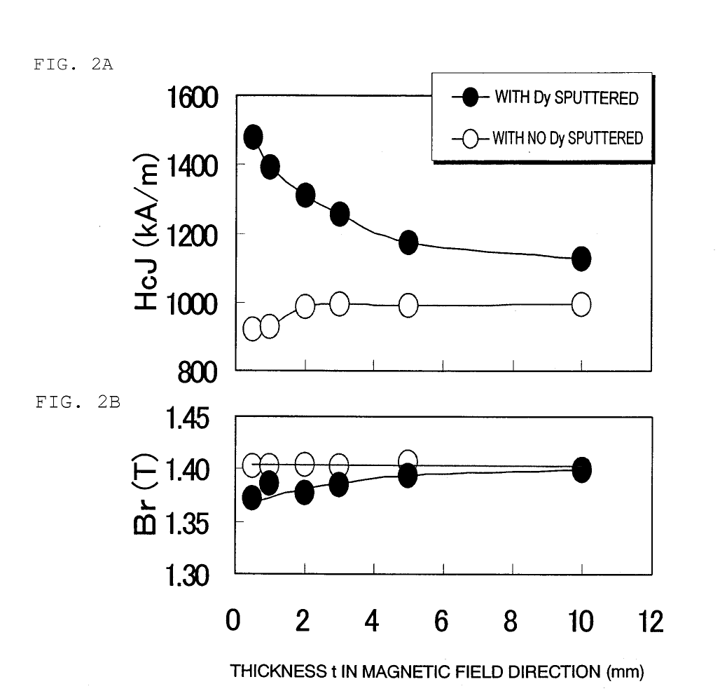

FIG. 2 is a graph showing how the remanence Br and coercivity HcJ changed with the thickness of the magnet in a situation where only a Dy layer (with a thickness of about 2.5 Mm) was formed by a sputtering process on the surface of a sintered magnet and thermally treated at about 900° C. for about 30 minutes. As can be seen from FIG. 2, when the magnet had a small thickness of less than about 3 mm, the coercivity HcJ increased sufficiently. However, the thicker the magnet, the less effectively the coercivity HcJ increased. This is because Dy has a short diffusion distance. That is to say, the thicker the sintered magnet, the greater the percentage of the portion where replacement by Dy was incomplete.

On the other hand, according to various preferred embodiments of the present invention, the grain boundary diffusion of the heavy rare-earth element RH is promoted by using at least one metallic element M that is selected from the group consisting of Al, Cu, Co, Fe and Ag. That is why the heavy rare-earth element RH can permeate deeper into the thick magnet and the performance of the magnet can be improved even at a lower diffusion temperature.

Hereinafter, specific examples of preferred embodiments of the present invention will be described.

### EXAMPLE 1

Alloy flakes with a thickness of about 0.2 mm to about 0.3 mm were made from an alloy ingot with the composition Nd_{12.5}Fe_{7.5}Co₁B₈ by a strip casting process. Next, a container was filled with these flakes and a hydrogen gas at about 500 kPa was occluded at room temperature and then released, thereby obtaining a powder in indefinite shapes with sizes of about 0.15 mm to about 0.2 mm. Thereafter, the powder was pulverized with a jet mill to obtain a fine powder with a size of approximately 3 Mm.

Subsequently, about 0.05 mass % of zinc stearate was added to, and mixed with, this fine powder. The mixture was pressed and compacted under a magnetic field. The green compact was loaded into a vacuum furnace and sintered at about 1,080° C. for one hour there, thereby obtaining a cubic magnet block material with a size of approximately 10 mm square.

Next, this cubic magnet block material was cut with a grindstone to obtain an Nd—Fe—B based rare-earth magnet with a length of about 10 mm, a width of about 10 mm and a thickness of about 5 mm. The magnet in this state was called comparative example sample (1), which had a thickness of 5 mm, a volume of 500 mm³, a surface area of 400 mm², and a surface area-volume ratio of 0.8 mm⁻¹.

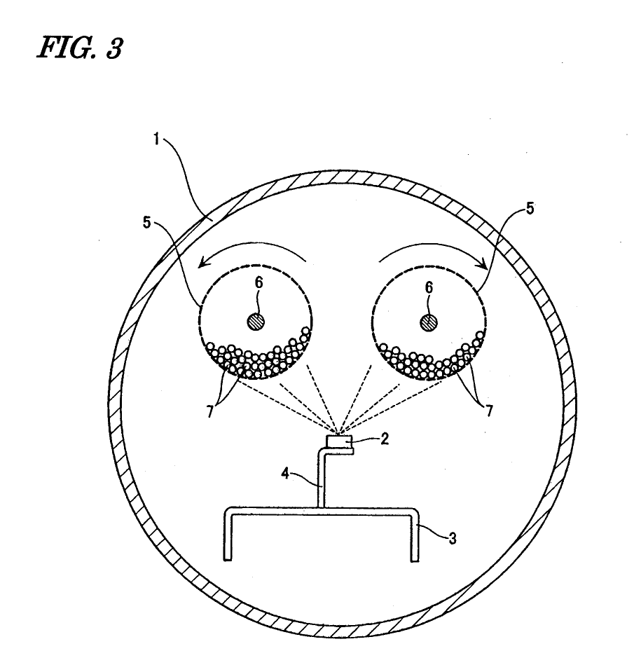

Thereafter, using the evaporation system shown in FIG. 3, an RHM alloy film was deposited on the surface of this Nd—Fe—B based rare-earth magnet. The system shown in FIG. 3 includes cylindrical barrels 5, which are arranged in a vacuum processing chamber 1 so as to store rare-earth magnets 7. These cylindrical barrels 5 are supported rotatably on rotating shafts 6. Also arranged inside the vacuum processing chamber 1 are a boat (evaporating portion) 2, a boat supporting stage 4 to support the boat 2, and a supporting table 3 on which the boat supporting stage 4 is mounted. A molten evaporative material, including a metallic element to be deposited on the surface of the rare-earth magnets 7, is put into the boat 2, heated with electric current supplied, and vaporized. In this manner, an alloy layer can be formed on the surface of the rare-earth magnets 7 in the barrels 5. This system can form a desired alloy layer on the entire surface of the rare-earth magnets 7 by rotating the barrels 5.

In this specific example, a Dy-70 mass % of Al alloy (dysprosium-aluminum alloy) metal was used as the molten evaporative material.

The actual evaporation-deposition process was carried out in the following manner. Three Nd—Fe—B based rare-earth magnets of a predetermined shape were arranged inside the vacuum processing chamber 1 of the evaporation system and then the chamber 1 was evacuated until the total pressure inside the vacuum vessel became approximately 1×10⁻¹ Pa, when a high-purity Ar gas was introduced. Next, a reverse sputtering process was carried out for approximately 10 minutes with an RF output of about 300 W applied, thereby removing the oxide film from the surface of the magnets. Subsequently, a DC output of about 300 W was applied, thereby heating, melting and vaporizing the DyAl (dysprosium-aluminum) alloy. In this manner, a DyAl alloy coating with a thickness of about 2 μm was deposited on the surface of the Nd—Fe—B based rare-earth magnets.

After the pressure inside the system was reset to the atmospheric pressure, these magnets coated with the alloy layer were transported to a globe box, which was connected to the evaporation system, without being exposed to the air. Next, the magnets were loaded into a small vacuum electric furnace, which was also arranged inside the globe box, and then thermally treated at a temperature of about 800° C. to about 1,000° C. for approximately 30 minutes.

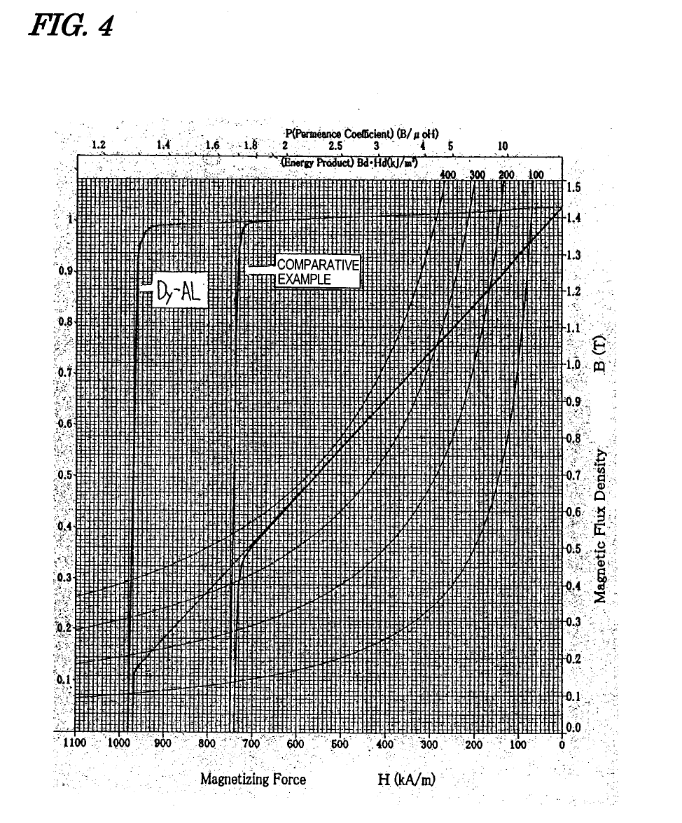

After a pulsed magnetizing field of about 3 MA/m was applied thereto, the respective samples had their magnetic properties measured with a BH tracer. FIG. 4 shows excerpts of the demagnetization curves of Comparative Example #1, which was not coated with the alloy film, and Example #1.

It was confirmed that the sample of a preferred embodiment of the present invention, which was coated with the Dy-70 mass % Al alloy film and then thermally treated, exhibited high coercivity, which increased about 30% compared to an Nd—Fe—B based rare-earth magnet that was not coated with the alloy film.

This marked effect was achieved probably because the DyAl alloy layer deposited would have diffused into the R-rich phase to form a Dy concentrated portion on the outer periphery of the Nd—Fe—B phase (as a main phase). Consequently, as can be seen easily from the demagnetization curve shown in FIG. 4, the coercivity HcJ increased compared to the non-treated Comparative Example #1.

### EXAMPLE 2

An Nd—Fe—B based rare-earth magnet with a length of about 10 mm, a width of about 10 mm, and a thickness of about 4 mm was made by a cutting process, and an RHM alloy film was deposited on the surface of this Nd—Fe—B based rare-earth magnet using the evaporation system shown in FIG. 3. A Tb-30 mass % Cu alloy (terbium-copper alloy) was used as the molten evaporative material.

The actual evaporation-deposition process was carried out in the following manner. Three Nd—Fe—B based rare-earth magnets that had been cut into a predetermined shape were arranged inside the vacuum vessel of an evaporation system and then a TbCu alloy (terbium-copper alloy) was heated, melted and vaporized. Other than that, the same process steps as those of Example #1 described above were carried out to deposit a TbCu alloy (terbium-copper alloy) coating to a thickness of about 2 X m on the surface of the Nd—Fe—B based rare-earth magnets.

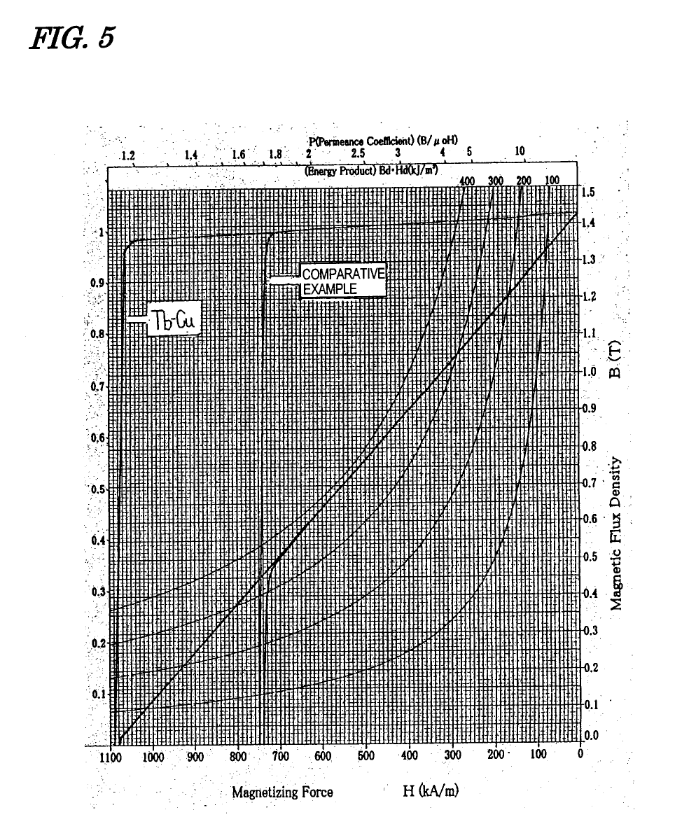

After a pulsed magnetizing field of about 3 MA/m was applied thereto, the respective samples had their magnetic properties measured with a BH tracer. FIG. 5 shows excerpts of the demagnetization curves of Example #2 and Comparative Example #2, which is shown in the following Table 1.

It was confirmed that the sample of a preferred embodiment of the present invention, which was coated with the Tb-30 mass % Cu alloy layer and then thermally treated, exhibited high coercivity, which increased about 40% compared to an Nd—Fe—B based rare-earth magnet that was not coated with the alloy film.

This dramatic effect was achieved probably because the Cu layer deposited would have diffused to promote the grain boundary diffusion of Tb and the permeation of Tb to the grain boundary inside the magnet.

### EXAMPLE 3

An Nd—Fe—B based rare-earth magnet with a length of about 10 mm, a width of about 10 mm, and a thickness of about 6 mm was made by a cutting process, and an RHM alloy layer was deposited on the surface of this Nd—Fe—B based rare-earth magnet using the evaporation system shown in FIG. 3. A Dy-20 mass % Fe alloy (dysprosium-iron alloy) was used as the molten evaporative material.

The actual evaporation-deposition process was carried out in the following manner. Three Nd—Fe—B based rare-earth magnets that had been cut into a predetermined shape were arranged inside the vacuum vessel of an evaporation system and then a DyFe alloy (dysprosium-iron alloy) was heated, melted and vaporized. Other than that, the same process steps as those of Example #1 described above were carried out to deposit a DyFe alloy (dysprosium-iron alloy) coating to a thickness of about 2 μm on the surface of the Nd—Fe—B based rare-earth magnets.

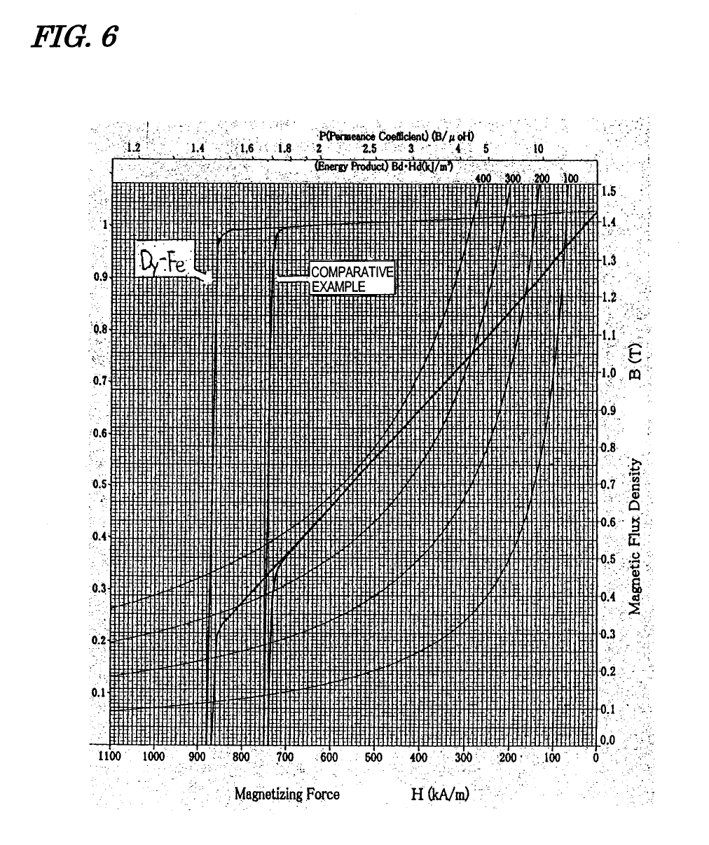

After a pulsed magnetizing field of about 3 MA/m was applied thereto, the respective samples had their magnetic properties measured with a BH tracer. FIG. 6 shows excerpts of the demagnetization curves of Example #3 and Comparative Example #3, which is shown in the following Table 1.

It was confirmed that the sample of a preferred embodiment of the present invention, which was coated with the Dy-20 mass % Fe alloy film and then thermally treated, exhibited high coercivity, which increased about 20% compared to an Nd—Fe—B based rare-earth magnet that was not coated with the alloy film.

### EXAMPLE 4

An Nd—Fe—B based rare-earth magnet with a length of about 10 mm, a width of about 10 mm, and a thickness of about 3 mm was made by a cutting process, and an RHM alloy film was deposited on the surface of this Nd—Fe—B based rare-earth magnet using the sputtering system shown in FIG. 3. Dy and Al were used as the molten evaporative materials.

The actual evaporation-deposition process was carried out in the following manner. Three Nd—Fe—B based rare-earth magnets that had been cut into a predetermined shape were arranged inside the vacuum vessel of an evaporation system and then Dy and Al were heated, melted and sputtered simultaneously. Other than that, the same process steps as those of Example #1 described above were carried out to deposit a DyAl alloy (dysprosium-aluminum alloy) film to a thickness of about 2 μm on the surface of the Nd—Fe—B based rare-earth magnets.

Specifically, this process step of depositing the alloy film was carried out as follows.

First, the deposition chamber of the sputtering system was evacuated to a pressure of about 6×10⁻⁴ Pa and then a high-purity Ar gas was introduced into the deposition chamber to maintain the pressure at approximately 1 Pa. Next, an RF power of about 300 W was applied between the electrodes in the deposition chamber, thereby subjecting the surface of the sintered magnet body to a reverse sputtering process for five minutes. This reverse sputtering process was carried out to clean the surface of the sintered magnet body. As a result, the oxide film could be removed from the surface of the magnet.

Then, a DC power of about 500 W and an RF power of about 30 W were applied between the electrodes in the deposition chamber, thereby sputtering the respective surfaces of the Dy and Al targets at the same time and depositing a DyAl alloy film to a thickness of about 2.0 μm on the surface of the sintered magnet body.

After the pressure inside the system was reset to the atmospheric pressure, these magnets coated with the alloy layer were transported to a globe box, which was connected to the evaporation system, without being exposed to the air. Next, the magnets were loaded into a small vacuum electric furnace, which was also arranged inside the globe box, and then thermally treated at a temperature of about 800° C. to about 900° C. for approximately 120 minutes.

After a pulsed magnetizing field of about 3 MA/m was applied thereto, the respective samples had their magnetic properties (i.e., remanence Br and coercivity HcJ) measured with a BH tracer. The results are shown in the following Table 1:

TABLE 1

| | | | | | | Sputtering process | | |
|---|---|---|---|---|---|---|---|---|
| | | Amount added | | | | conditions | | |
| | Sputtered | (mass %) | | Br | HcJ | Dy | Al | |
| | element(s) | Dy | Al | (T) | (MA/m) | target | target | Time |
| Cmp. Ex. 1 | | | | 1.40 | 1.00 | | | |
| Cmp. Ex. 2 | Dy | 0.25 | | 1.39 | 1.26 | DC | | 36 min |
| | | | | | | 500 W | | |
| Cmp. Ex. 2 | Dy | 0.46 | | 1.38 | 1.32 | DC | | 65 min |
| | | | | | | 500 W | | |
| Ex. 1 | Dy + Al | 0.12 | 0.04 | 1.39 | 1.36 | RF | DC | 65 min |
| | | | | | | 500 W | 750 W | |
| Ex. 2 | Dy + Al | 0.35 | 0.07 | 1.39 | 1.41 | DC | RF | 130 |
| | | | | | | 250 W | 500 W | min |

As can be seen easily from this Table 1, it was discovered that high coercivity was realized by sputtering Dy and Al simultaneously to deposit an alloy film and then thermally treating the alloy film.

As described above, it was confirmed that by depositing an alloy layer, including low-melting metals such as Dy, which is a heavy rare-earth element, and Al, on the surface of a sintered magnet body and subjecting it to a diffusion process, the grain boundary diffusion of Dy could be promoted. As a result, Dy can start to be diffused at a lower heat treatment temperature than the conventional process and Dy can permeate deeper into the magnet. Consequently, the coercivity HcJ can be increased without getting the remanence Br decreased by Al. In this manner, the coercivity HcJ of an entire thick magnet can be increased efficiently with the required amount of Dy reduced.

Optionally, to increase the weather resistance of the magnet, a coating of Al or Ni may be formed on the outer surface of the RHM layer.

According to various preferred embodiments of the present invention, main phase crystal grains, around which a heavy rare-earth element RH has been concentrated efficiently, can be formed effectively inside the sintered magnet body, too.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-9. (canceled)

10. A rare-earth sintered magnet comprising:
an R—Fe—B based rare-earth sintered magnet body; and
an RHM alloy layer, which includes a heavy rare-earth element RH, which is at least one rare-earth element selected from the group consisting of Dy, Ho and Tb, and a metal M, which is at least one metallic element selected from the group consisting of Al, Cu, Fe and Ag, and which has been formed on the surface of the sintered magnet body.

11. The rare-earth sintered magnet of claim 10, wherein the magnet has a thickness of about 10 mm or less.

12. The rare-earth sintered magnet of claim 10, wherein the RHM alloy layer includes at least one alloy selected from the group consisting of DyAl, DyCu, DyFe, DyAg, TbAl, TbCu, TbFe, TbAg, DyAlCu, DyFeAl, DyFeAg and TbAlCu.

13. A method for producing a rare-earth sintered magnet, the method comprising the steps of:
providing an R—Fe—B based sintered magnet body;
forming an RHM alloy layer, which includes RH, which is at least one rare-earth element selected from the group consisting of Dy, Ho and Tb, and a metal M, which is at least one metallic element selected from the group consisting of Al, Cu, Fe and Ag, on the surface of the R—Fe—B based sintered magnet body; and
conducting a heat treatment at a temperature of about 500° C. to about 1,000° C.

14. The method of claim 13, wherein the step of forming the RHM alloy layer includes forming the RHM alloy layer by an evaporation process, a vacuum evaporation process, a sputtering process, an ion plating process, an ion vapor deposition process, an electrochemical vapor deposition process or a dipping process.

15. The method of claim 13, wherein the step of forming the RHM alloy layer includes making the RHM alloy layer of at least one alloy selected from the group consisting of DyAl, DyCu, DyFe, DyAg, TbAl, TbCu, TbFe, TbAg, DyAlCu, DyFeAl, and DyFeAg.

16. The method of claim 13, wherein the step of forming the RHM alloy layer and the step of conducting the heat treatment are repeatedly performed a number of times.

17. The method of claim 13, further comprising the step of heating the R—Fe—B based sintered magnet body at a temperature of about 500° C. to about 1,000° C. before the RHM alloy layer is formed thereon.

18. The method of claim 13, wherein the R—Fe—B based sintered magnet body has a thickness of about 10 mm or less.
